(19) United States
(12) Patent Application Publication
(10) Pub. No.: US 2010/0194058 A1
(43) Pub. Date: Aug. 5, 2010

(54) HYBRID SEALS

(75) Inventors: Zlatomir Kircanski, Cumberland, RI (US); Scott J. MacKenzie, Lexington, MA (US)

Correspondence Address: MAURICE M KLEE, 1951 BURR STREET, FAIRFIELD, CT, 06824, US

(73) Assignee: ACS Industries, Inc., Lincoln, RI (US)

(21) Appl. No.: 12/365,958

(22) Filed: Feb. 5, 2009

(51) Int. Cl. F02F 11/00; B23P 15/00

(52) U.S. Cl. 277/597; 29/527.1

(57) ABSTRACT

Hybrid seals (117) are provided which include a metallic component (127) and a flexible, non-metallic, heat resistant component (129), e.g., graphite, which are fully integrated in the finished seal and thus not subject to delamination. The hybrid seals (117) can be produced from hybrid heat resistant strips (107) that can be wrapped into a preform (109) and then compression molded to form the hybrid seal (117). The hybrid strips (107) have a core (111) that comprises a flexible, non-metallic, heat resistant material and a metal mesh (113) knitted around the core. Prior to being formed into a preform (109), the core and the metal mesh are crimped together to begin the process of integrating the metallic and non-metallic components of the seal. The compression molding completes the integration.

### FIELD

This disclosure relates to hybrid seals and hybrid gaskets (referred to herein collectively as “hybrid seals”) that employ a composite of a flexible, non-metallic, heat resistant material (e.g., graphite or mica) and an overknitted wire mesh.

### BACKGROUND

This disclosure relates to hybrid seals, including hybrid sliding seals, useful for high temperature applications, such as in conduits for combustion exhaust gases. Applications utilizing high temperature seals are described in U.S. Pat. No. 4,683,010, U.S. Pat. No. 4,951,954, U.S. Pat. No. 6,286,840, U.S. Pat. No. 7,012,195, and International Publication No. WO 2007/103327, the disclosures of which are incorporated herein by reference.

Flexible graphite, such as described in U.S. Pat. No. 3,404,061 (the disclosure of which is incorporated herein by reference), has been known for decades. It is sold under such trademarks as GRAFOIL (Graftech International Holdings Inc., Parma, Ohio). Flexible graphite sheet is a rolled sheet product manufactured by taking a high quality particulate graphite flake and processing it through an intercalation process using strong mineral acids. The flake is then heated to volatilize the acids and expand the flake to many times its original size. The expansion process produces a wormlike, dendritic-like structure that can be readily formed by molding or calendaring into sheets. Binders are generally not introduced in the manufacturing process. The result is a gasket sheet product that exhibits excellent tensile strength and, for industrial applications, typically exceeds 97% elemental carbon by weight.

Seals made from flexible graphite sheet are typically made by stamping or cutting a circular piece from the sheet (or a perimeter of the desired geometry), which leads to a significant amount of waste of the expensive graphite material.

In light of the desirability of using graphite and seeking to reduce waste of the flexible graphite sheet material, this disclosure provides a high temperature seal using a flexible graphite sheet and wasting very little of the graphite sheet, if any, in the manufacturing process. As an alternate to graphite, the disclosure also provides high temperature seals employing other flexible, non-metallic, heat resistant materials such as mica.

### SUMMARY

In accordance with a first aspect, a hybrid heat resistant strip (107) is provided which has a longitudinal axis and comprises:

(a) a core (111) in the form of a strip, said core comprising a flexible, non-metallic, heat resistant material; and

(b) a metal mesh (113) knitted around the core;

wherein the core (111) and the metal mesh (113) are crimped together subsequent to the mesh (113) having been knitted about the core (111), said crimping producing corrugations that are oriented substantially perpendicular to the longitudinal axis of the strip (107).

In accordance with a second aspect, a heat resistant seal (117) is provided that comprises a flexible graphite strip (111) overknitted with a wire mesh (113), crimped, and compressed into an annulus.

In accordance with a third aspect, a method of making a hybrid heat resistant seal (117) is provided that comprises:

(a) providing a core (111) that comprises a flexible, non-metallic, heat resistant material;

(b) knitting a metal mesh (113) around the core (111) to form a composite (115);

(c) crimping the composite (115);

(d) forming a preform (109) from the crimped composite (115); and

(e) compressing the preform (109) to form the seal (117);

wherein the metal mesh (113) is distributed substantially throughout the flexible, non-metallic, heat resistant material after step (e).

The reference numbers used in the above summaries of the various aspects of the disclosure are only for the convenience of the reader and are not intended to and should not be interpreted as limiting the scope of the invention. More generally, it is to be understood that both the foregoing general description and the following detailed description are merely exemplary of the invention and are intended to provide an overview or framework for understanding the nature and character of the invention.

Additional features and advantages of the invention are set forth in the detailed description which follows, and in part will be readily apparent to those skilled in the art from that description or recognized by practicing the invention as described herein. The accompanying drawings are included to provide a further understanding of the invention, and are incorporated in and constitute a part of this specification. It is to be understood that the various features of the invention disclosed in this specification and in the drawings can be used in any and all combinations.

### BRIEF DESCRIPTION OF THE DRAWINGS

FIG. 1 depicts a method of forming a hybrid seal according to certain aspects of this disclosure.

FIG. 2 depicts four representative cross sections of hybrid seals according to this disclosure.

FIG. 3 is a photomicrograph illustrating the integrated structure of hybrid seals according to this disclosure.

FIG. 4 is a photomicrograph illustrating the layered structure of the seals of the prior art.

The reference numbers used in the figures refer to the following:
103 sheet of flexible, non-metallic, heat resistant material
105 cut line
107 hybrid strip
109 preform (also referred to as a rolled structure)
111 core of hybrid strip (also referred to as a strip)
113 metal mesh of hybrid strip
115 composite, i.e., overknitted core prior to corrugation
117 hybrid seal
123 crimping rollers
125 projections
127 metallic component of hybrid seal
129 flexible, non-metallic, heat resistant component of hybrid seal

### DETAILED DESCRIPTION OF THE PREFERRED EMBODIMENTS

As discussed above, in certain of its aspects, this disclosure relates to hybrid heat resistant strips 107 that can be wrapped into a rolled structure 109 (a preform) and then compression molded into a hybrid seal 117, e.g., a hybrid seal for use in an exhaust system. The hybrid strips 107 comprise: (1) a core 111 that comprises a flexible, non-metallic, heat resistant material and (2) a metal mesh 113 knitted around the core wherein the core and the metal mesh are crimped together subsequent to the mesh having been knitted about the core. The crimping is performed to produce corrugations that are oriented substantially perpendicular to the longitudinal axis (length direction) of the hybrid strip.

The flexible, non-metallic, heat resistant material making up the core can be flexible graphite, such as that sold under the GRAFOIL trademark (see above). Alternatively, the flexible, non-metallic, heat resistant material can be mica. The core can comprise a single material or a combination of materials, e.g., the core can comprise one or more strips of graphite and one or more strips of mica. Whatever material or materials are used to form the core, because the core is in the form of a strip, the amount of material that is wasted is substantially reduced in comparison to prior techniques where sheets of the heat resistant material were stamped or cut to produce the desired seal configuration. Indeed for many applications, the wastage can be essentially zero.

Once formed, the core 111 is overknit with the wire mesh 113 using conventional wire knitting equipment. The wire used in the knitting can be ferritic or austenitic wire having a diameter in, for example, the range of 0.004 to 0.008 inches. For example, wire composed of 304, 316 or 430 stainless steel can be used, but other types of wire may also be used depending on the application. The density of the knit will depend on the particular application. For example, knits produced using a knitting head having 6-18 needles produce satisfactory wire meshes surrounding the core. The ends of the overknitted cores can be cut at 90° or at an angle to create a greater surface area for bonding of the ends within the structure of the final seal during the compression process (see below).

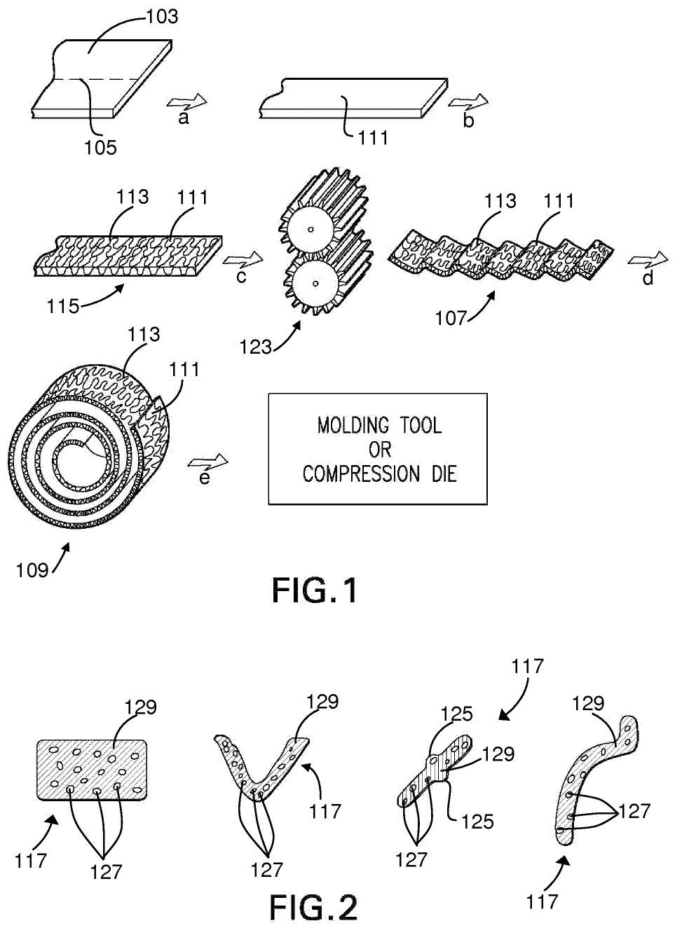

FIG. 1 illustrates a process for producing a hybrid seal. The process begins with a sheet 103 of a flexible, non-metallic, heat resistant material, e.g., graphite. In step (a), the sheet is cut along line 105 parallel to an edge of the sheet to produce core 111 having a length equal to or less than the length of sheet 103, a width defining top and bottom sides, and a thickness being the smallest dimension. In step (b), the core 111 is overknit with ferritic or austenitic wire 113 to form composite 115. Next, in step (c), the composite 115 is crimped by contact with rollers 123, one or both (as shown) of which have ridges for imparting a crimping pattern to produce corrugated hybrid strip 107.

In step (d), hybrid strip 107 is rolled (wound) into preform 109. The winding of the preform can be performed in various ways. For example, the hybrid strip can be wound with its width oriented parallel to the winding axis or at an angle to that axis. Also, the winding can take place in a plane or can move out of a plane to form a helix which typically will have each subsequent turn overlying the previous turn. The pitch (frequency) of the corrugations is selected based on the radius at which the strip will be wound so as to avoid unacceptable stress levels in the strip and/or unacceptable crushing of the corrugations. Generally, a shorter pitch (higher frequency per length) will allow for a smaller winding radius. As a general guide, for a seal having a diameter of 4″, the corrugations will have a pitch of 3/16″-¼″, while for a seal having a diameter of 12″, the corrugations will have a pitch of ¼″- 5/16″, although other pitches can, of course, be used for these and other diameters. In general, the depth of the corrugations needs to be great enough to unite the wire mesh with the flexible, non-metallic, heat resistant material. Corrugations having a depth in the range of 1/16″ to 3/16″ have been found suitable for this purpose, although larger or smaller depths can be used for some applications if desired.

Finally, in step (e), preform 109 is subjected to compression molding using a molding tool or a compression die to produce the desired seal. Depending on the mold/die geometry, the finished seal can have a variety of cross-sectional shapes. FIG. 2 illustrates representative examples, i.e., from left to right in the figure, a rectangular cross-section, a V-shaped cross-section, a cross-section with circumferential projections 125, and a curved cross-section.

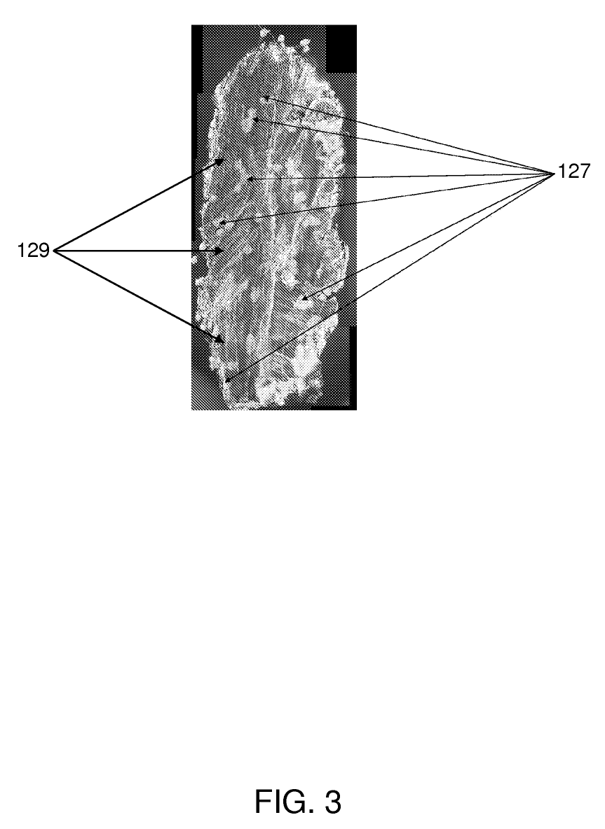

Importantly, irrespective of the particular cross-section used, the hybrid seals have their metal component distributed substantially throughout their non-metallic component, as shown at 127 (metal component) and 129 (non-metallic component). This distributed construction is referred to herein as an “integrated” structure. This integration is a result of the combination of corrugation step (c), which begins the integration, and compression molding step (e), which fully integrates the wire mesh with the flexible, non-metallic, heat resistant material. This full integration is illustrated in FIG. 3 which is a photomicrograph of a cross-section of a seal produced using the method of FIG. 1 with graphite as the flexible, non-metallic, heat resistant material. As can be seen in this figure, the wire mesh and the graphite have been fully united to produce a robust, non-delaminable structure.

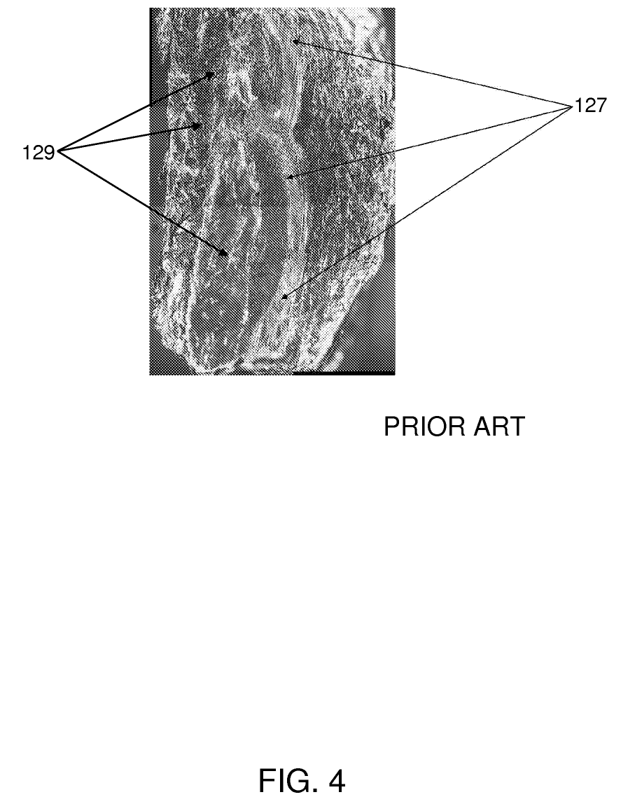

Previous attempts to make a seal including a sheet of a flexible, non-metallic, heat resistant material, e.g., a flexible graphite sheet, and a metal component involved sandwiching the metal component between sheets of the heat resistant material. The molding of such structures gave parts that were susceptible to delamination. FIG. 4 is a photomicrograph of a cross-section through a seal produced using the sandwich approach, where again, graphite was the flexible, non-metallic, heat resistant material. As can be seen, the metallic component and the graphite remain segregated from one another, thus leading to the possibility of separation during use. In contrast, encasing a strip of the flexible material in a wire mesh, corrugating the resulting composite, forming a preform from the composite, and then compressing the preform to produce the seal provides a part that does not delaminate.

The present devices are useful as seals and/or gaskets in applications where gas flow in a conduit is to be channeled to a treatment device (e.g., a catalytic converter), where conduits join by one sliding inside the other, and similar installations. Accordingly, the seals preferably define an annulus having a circular or ellipsoid geometry after molding, although any curved or polygonal geometry (or combination thereof) can be produced if desired.

In summary, this invention provides a high temperature seal comprising a strip of flexible, non-metallic, heat resistant material, e.g., graphite, overknit and crimped and compressed (formed) into a desired geometry, e.g., an oval or circular geometry

A variety of modifications that do not depart from the scope and spirit of the invention will be evident to persons of ordinary skill in the art from the foregoing disclosure. For example, although the invention has been described in terms of cores which are composed of one or more flexible, non-metallic, heat resistant materials, the core can in addition include one or more layers of a metal substrate such as a woven or knitted mesh strip or a strip of flexible expanded metal. The inclusion of such a substrate will generally result in a more rigid finished seal. The following claims are intended to cover the specific embodiments set forth herein as well as modifications, variations, and equivalents of those embodiments of the foregoing and other types.

What is claimed is:

1. A hybrid heat resistant strip which has a longitudinal axis and comprises:
(a) a core in the form of a strip, said core comprising a flexible, non-metallic, heat resistant material; and
(b) a metal mesh knitted around the core;
wherein the core and the metal mesh are crimped together subsequent to the mesh having been knitted about the core, said crimping producing corrugations that are oriented substantially perpendicular to the longitudinal axis of the strip.

2. The strip of claim 1 wherein the flexible, non-metallic, heat resistant material comprises graphite.

3. The strip of claim 1 wherein the flexible, non-metallic, heat resistant material comprises mica.

4. The strip of claim 1 wherein the core comprises a first layer of flexible, non-metallic, heat resistant material and a second layer of flexible, non-metallic, heat resistant material.

5. The strip of claim 4 wherein the first and second layers have the same composition.

6. The strip of claim 4 wherein the first and second layers have different compositions.

7. The strip of claim 1 wherein the core comprises a layer of a flexible metallic material.

8. A heat resistant seal comprising a strip according to claim 1, wherein the strip is formed into a preform and the preform is compressed to form the seal.

9. The seal of claim 8 wherein the seal has a rectangular cross-section.

10. The seal of claim 8 wherein the seal has an angled cross-section.

11. The seal of claim 8 wherein the seal has a cross-section that includes at least one circumferential projection.

12. The seal of claim 8 wherein the seal has a curved cross-section.

13. The seal of claim 8 wherein in the finished seal, the strip's metal mesh is distributed substantially throughout the strip's flexible, non-metallic, heat resistant material.

14. A heat resistant seal comprising a flexible graphite strip overknitted with a wire mesh, crimped, and compressed into an annulus.

15. A method of making a hybrid heat resistant seal comprising:
(a) providing a core that comprises a flexible, non-metallic, heat resistant material;
(b) knitting a metal mesh around the core to form a composite;
(c) crimping the composite;
(d) forming a preform from the crimped composite; and
(e) compressing the preform to form the seal;
wherein the metal mesh is distributed substantially throughout the flexible, non-metallic, heat resistant material after step (e).

16. The method of claim 15 wherein the flexible, non-metallic, heat resistant material is graphite.

17. The method of claim 15 wherein the flexible, non-metallic, heat resistant material is mica.

18. The method of claim 15 wherein the core comprises more than one flexible, non-metallic, heat resistant material.

19. The method of claim 18 wherein the core comprises graphite and mica.

20. The method of claim 15 wherein the core comprises a metallic material.
